(19) United States
(12) Patent Application Publication
(10) Pub. No.: US 2012/0214522 A1
(43) Pub. Date: Aug. 23, 2012

(54) WIRELESS FREQUENCY SETTING METHOD AND DEVICE

(75) Inventors: J. Vern Cunningham, Aurora (CA); Mircea Dan Paul, Richmond Hill (CA); Daniel Budurea, Mississauga (CA)

(73) Assignee: CUBE INVESTMENTS LIMITED, Aurora, ON (CA)

(21) Appl. No.: 13/505,254

(22) PCT Filed: Oct. 26, 2010
(86) PCT No.: PCT/CA2010/001672

§ 371 Date: Apr. 30, 2012

Related U.S. Application Data
(60) Provisional application No. 61/256,963, filed on Oct. 31, 2009.
(60) Provisional application No. 61/257,224, filed on Nov. 2, 2009.

(51) Int. Cl. H04W 72/04

(52) U.S. Cl. 455/500; 455/77

(57) ABSTRACT

An appliance and a method of determining a wireless communication frequency range from received AC power input comprising automatically determining an AC power characteristic from the AC mains power, automatically mapping the determined AC power characteristic to the wireless frequency range within a pre-determined wireless frequency range, and automatically selecting the wireless communication frequency range to communicate with an auxiliary appliance.

### CROSS-REFERENCE TO OTHER APPLICATIONS

This application claims priority from and the benefit of the filing dates of U.S. Provisional Patent Application No. 61/256,963 filed on Oct. 31, 2009 and U.S. Provisional Patent Application No. 61/257,224 filed on Nov. 2, 2009, under title WIRELESS FREQUENCY SETTING METHOD AND DEVICE. The contents of the above applications is hereby incorporated by reference into the detailed description hereof.

### FIELD

The present invention relates to appliances having a wireless communication subsystem.

### BACKGROUND

Appliances often use wireless communication systems. Permitted communication frequency can differ from jurisdiction to jurisdiction. For example, unlicensed use of radio frequencies may occur in the industrial, scientific and medical (ISM) radio bands 900-928 MHz in the Americas (centre frequency 915 MHz), or in the 868-868.6 MHz bands in Europe. Manufacturers often provide different products for different jurisdictions to comply with the different transmission frequency requirements. Alternatively, manufacturers allow for setting of the transmission frequency after manufacturing, for example by setting switches on the appliance.

For example, many modem buildings may have central vacuum cleaning systems. These systems have a suction motor to create a vacuum in a series of pipes through the building. A user of the system connects a flexible hose to one of the pipes. The hose has a handle for the operator to grasp, and may also include a control interface. The handle is further connected to one or more cleaning accessories.

The suction motor is housed in a motor housing that typically forms part of a central vacuum unit. The central vacuum unit also has a receptacle portion for receiving dust and other particles picked up through the cleaning accessories and transported by the vacuum through the hose and pipes.

The central vacuum unit is usually placed in a central location that is easily accessible for emptying the receptacle. However, the central vacuum unit may be located some distance away from a user of the system. As such, the central vacuum cleaning system may include a handle with a remote control unit having wireless communications capabilities. The central vacuum unit may include a central control unit with a receiver for wirelessly receiving command signals from the remote unit at on the handle. An example of such a wireless control system has been disclosed in U.S. Pat. No. 6,856,113 of J. Vern Cunningham, issued on Feb. 15, 2005, the content of which is hereby incorporated by reference.

Wireless control units are required to operate at different radio frequencies in different jurisdictions. Improvements to, or alternatives for, existing vacuum cleaning systems having wireless control interfaces are desirable.

### BRIEF DESCRIPTION OF THE FIGURES

FIG. 1A shows a voltage-versus-time graph of a 60 Hz mains and a graph of its zero crossings.

FIG. 1B shows a voltage-versus-time graph of a 50 Hz mains and a graph of its zero crossings.

FIG. 2 is a block diagram of an example implementation to determine an appropriate wireless frequency from measuring AC line frequency.

FIG. 3 is a block diagram of an example programmable control unit with integrated communication subsystem in a central vacuum cleaning system application.

FIG. 4 is an exemplary detailed schematic diagram of an example implementation of the programmable control unit of FIG. 3.

FIG. 5 is a flowchart of an example implementation of a method to set a wireless communication frequency of a first appliance.

FIG. 6 is a flowchart of another example implementation of a method to set a wireless communication frequency of a second appliance to wirelessly communicate with the first appliance of the method of FIG. 5.

Similar reference numerals have been used in different figures to denote similar objects.

### DETAILED DESCRIPTION

It is to be noted that numerous components are similar for different embodiments described herein, and components from one embodiment can be used on other embodiments. The description for similar components in different embodiments applies equally to all embodiments unless the context specifically requires otherwise. Components from one embodiment can be applied to other embodiments unless the context specifically requires otherwise, and specific reference to the cross-application of such components will not be made for each embodiment, but is expressly stated hereby.

In this description the operation of vacuum cleaners having wireless control interfaces will be discussed. However, it can be appreciated that other appliances having one or more wireless communication interfaces may embody the systems and methods described herein. For example, an appliance can include a furnace with a wireless temperature control interface communicating with wireless temperature sensors in each room. As a further example, an appliance can include an energy recovery ventilator (ERV) in communication with a wireless control unit of a central vacuum cleaning system, an example of which is disclosed in US Publication No. 2007/0079467 A1 of J. Vern Cunningham, published on Apr. 12, 2007, the content of which is hereby incorporated by reference.

In one aspect, this description discloses an appliance comprising: a mains power input for accepting AC mains power, a wireless communication subsystem, a power characteristic determinator linked to the mains power input for determining an AC power characteristic of the AC mains power, and a control unit linked to the power characteristic determinator and the wireless communication subsystem, wherein the control unit is configured to set a wireless communication frequency of the wireless communication subsystem within a pre-determined wireless communication frequency range based on the determined AC power characteristic.

In a further aspect, this description discloses a system comprising the above appliance as a first appliance and comprising a second appliance, the second appliance comprising: a second wireless communication subsystem configured to communicate on a first wireless communication frequency within a first pre-determined wireless communications frequency range; and a second control unit configured to control the second wireless communication subsystem to communicate on an alternate wireless communication frequency within a pre-determined wireless communication frequency range different from the first pre-determined wireless communication frequency range if the second wireless communication subsystem fails to communicate with the first appliance on the first wireless communication frequency.

In another aspect, this description discloses a method of setting a wireless communication frequency of an appliance, the method comprising: automatically determining an AC power characteristic from AC mains power of the appliance, automatically mapping the determined AC power characteristic to a wireless communication frequency within a pre-determined wireless frequency range based on the determined AC power characteristic, and automatically setting the wireless communication frequency of the appliance to the mapped wireless communication frequency.

In a further aspect, this description discloses a method of setting a wireless communication frequency of a system comprising a first appliance and a second appliance, the method comprising: automatically setting a wireless communication frequency of the first appliance in accordance with the above method; the second appliance attempting to communicate with the first appliance on a wireless communication frequency within a first pre-determined wireless communication frequency range, and if the second appliance fails to communicate with the first appliance on the wireless communication frequency within the first pre-determined wireless communication frequency range, then automatically setting the second appliance to communicate on an alternate wireless communication frequency within a second pre-determined wireless communication frequency range different from the first pre-determined wireless communication frequency range.

Other aspects and embodiments, and details of the above embodiments, will be evident from the further description herein.

As stated previously, different wireless transmission frequencies within different ranges are sometimes required to be used from jurisdiction to jurisdiction, for example depending on whether an appliance is being operated in Europe (868.0-868.6 MHz range) or in the Americas (900-928 MHz range). AC mains power can be provided in different frequencies from jurisdiction to jurisdiction, for example depending on whether the appliance is being operated in Europe (where 50 Hz is primarily used) or in the US or Canada (where 60 Hz is primarily used). As can be seen, different AC mains power frequencies from one jurisdiction to another jurisdiction can correlate to different wireless transmission frequencies from the one jurisdiction to another jurisdiction. Similarly, other AC mains power characteristics such as AC voltage may change from jurisdiction to jurisdiction. In the US and Canada 110-120 VAC is generally used, while in Europe approximately 220-240 VAC is generally used. As will be further described, a wireless communication frequency for the appliance to use for wireless communication is set within a pre-determined wireless communication frequency range based a determined AC power characteristic of the AC mains power provided to the appliance.

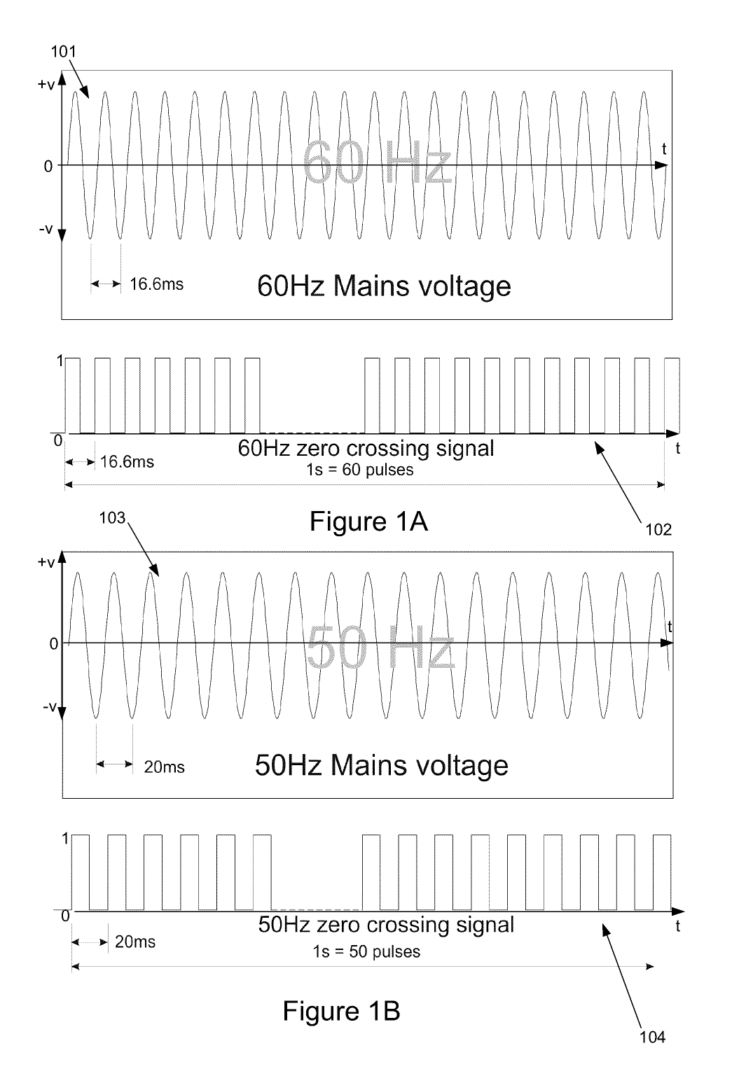

Referring to FIG. 1A, 60 Hz AC mains has a voltage-versus-time representation as shown in voltage graph 101 and zero-crossings as shown in zero-crossing graph 102. For both graphs, voltage is denoted by the vertical axis, and time is denoted by the horizontal axis.

Referring to FIG. 1B, 50 Hz AC mains power has a voltage-versus-time representation as shown in voltage graph 103 and zero-crossings as shown in zero-crossing graph 104. For both graphs, voltage is denoted by the vertical axis, and time is denoted by the horizontal axis.

One method of determining AC mains power frequency is to count the number of “zero crossings” within a given amount of time. A “zero crossing” happens when a function changes from positive to negative, or vice versa, as represented by a crossing of the horizontal axis (zero value on the vertical axis). In AC, a zero-crossing is the instantaneous point at which there is no AC voltage present. For example, for graph 101 from FIG. 1A, 60 Hz AC mains power will cross the horizontal axis 120 times in 1 second. In another example, for graph 103 from FIG. 1B, 50 Hz AC mains power will cross the horizontal axis 100 times in 1 second. Thus, counting the number of zero crossings within a given period of time (in this case 1 second) provides an indication of the AC power frequency since the AC power frequency is equal to 2 times the number of counts within the given period of time.

Alternatively, an indication of AC power frequency may also be determined by counting positive “zero crossings” within a given amount of time (in this case 1 second). A positive “zero crossing” happens when a function changes from positive to negative, but NOT vice versa, as represented by a crossing of the horizontal axis from below the horizontal axis to above the horizontal axis. For example, for graph 101 from FIG. 1A, a 60 Hz AC mains input will cross the horizontal axis from below the horizontal axis to above the horizontal axis 60 times in 1 second. In another example, for graph 103 from FIG. 1B, a 50 Hz AC mains power will cross the horizontal axis from below the horizontal axis to above the horizontal axis 50 times in 1 second. Thus, counting the number of positive zero crossings within a given period of time (in this case 1 second) also provides an indication of the AC power frequency. It can be appreciated that counting negative zero crossings will yield the same result as counting positive zero crossings. Other methods of determining an indication of AC mains power frequency can be used such as counting peaks (transitions from increasing voltage to decreasing voltage or transitions from decreasing voltage to increasing voltage).

Other AC mains power characteristics that can differ from jurisdiction to jurisdiction include voltage amplitude, for example peak voltage (+V to −V), peak to peak, and average voltage (such as root means square voltage). Such other characteristics can alternatively, or in addition, be used to map AC mains power characteristics to wireless communication frequency.

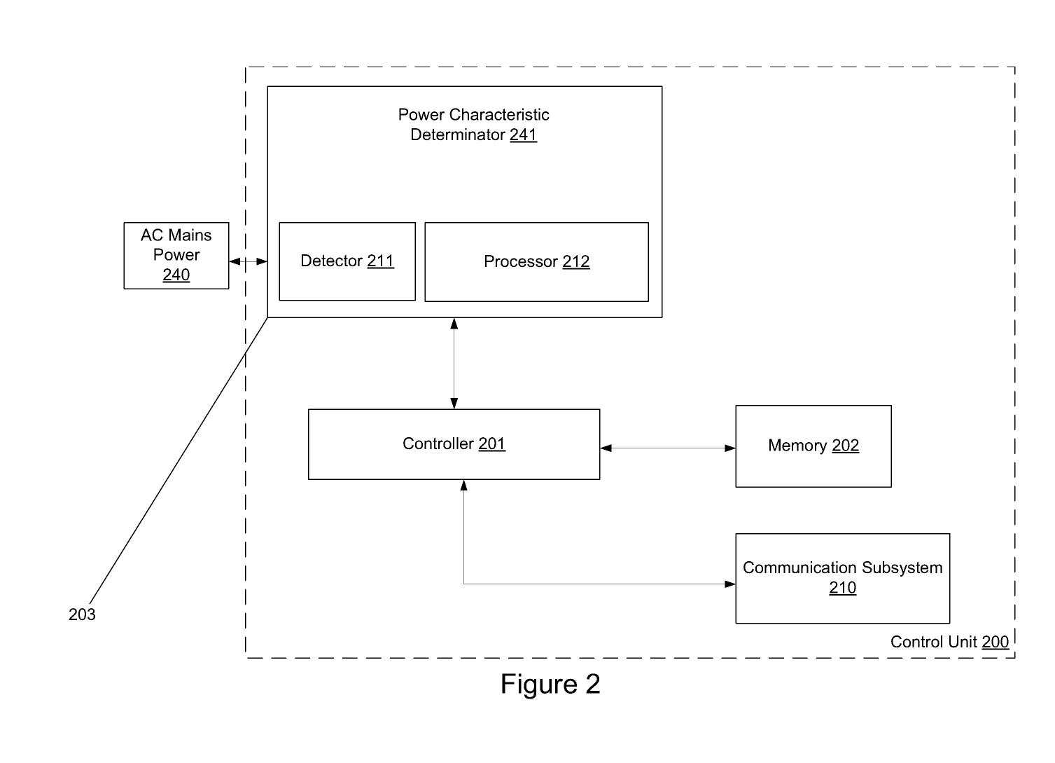

Referring now to FIG. 2, an example embodiment of control unit 200 to set an appropriate wireless communication frequency based on AC mains power characteristic is shown. A control unit 200 includes a power characteristic determinator 241 together with controller 201, memory 202, an input 203 for AC mains power 240, and wireless communication subsystem 210. Power characteristic determinator 241 is linked to controller 201 and AC mains power 240. Controller 201 is linked to memory 202 and communication subsystem 210. Power characteristic determinator 241 comprises a detector 211 and a processor 212.

In operation, AC mains power 240 supplies AC power to the power characteristic determinator 241. The detector 211 detects one or more power characteristics of the AC main power 240. For example, the detector 211 can detect a frequency characteristic of the AC main power 240. In alternate embodiments, the detector 211 can detect a voltage amplitude characteristic of the AC main power 240. Alternatively, the detector 211 can detect a combination of frequency characteristic and voltage amplitude characteristic of the AC main power 240. The following exemplary description will be made primarily with respect to the detector 211 detecting frequency; however, it is understood that the description is not limited to only frequency as a power characteristic.

Accordingly, detector 211 can be configured to notify the processor 212 whenever a zero crossing occurs in the AC power supplied by AC main power 240. Over a 1 second interval, processor 212 increments a counter whenever detector 211 notifies it that a zero crossing has occurred. After the 1 second interval is over, the value of the counter is an indication of the AC power frequency being supplied by AC mains power 240.

The indication of AC power frequency is then transmitted by the processor 212 to controller 201. Using the received indication of AC power frequency, controller 201 then maps the indication of AC power frequency to a wireless communication frequency within a pre-determined wireless communication frequency range. It is noted that a range need not be specified by the mapping. The mapping can specify a specific communication frequency. Examples described herein will utilize specific wireless communication frequencies for ease of description. Controller 201 then controls communication subsystem 210 to set the wireless transmission frequency of the communication subsystem 210 to the mapped wireless communication frequency within the pre-determined wireless communication frequency range. For example, an AC mains power frequency of less than 55 Hz is mapped to a wireless communication frequency within a range of 868.0-868.6 MHz (for Europe) such as 868.3 MHz, and an AC mains power frequency of greater than 55 Hz is mapped to a wireless communication frequency with a range of 900-928 MHz (for US or CA) such as 915 MHz. Mapping can be as simple as programming the respective frequencies of a control program for the controller, providing the mapping in hardware, or a combination of both.

Where additional frequencies are used (for example, some jurisdictions utilize detectable frequencies different from 50 Hz and 60 Hz) or when additional power characteristics (such as voltage) are used, it may be desirable to store a table of concordance between power characteristics and wireless communication frequencies in memory 202 to be accessed by the controller 201. The memory 202 has been shown separately from the controller 201; however, the memory 202 may form part of the controller 201.

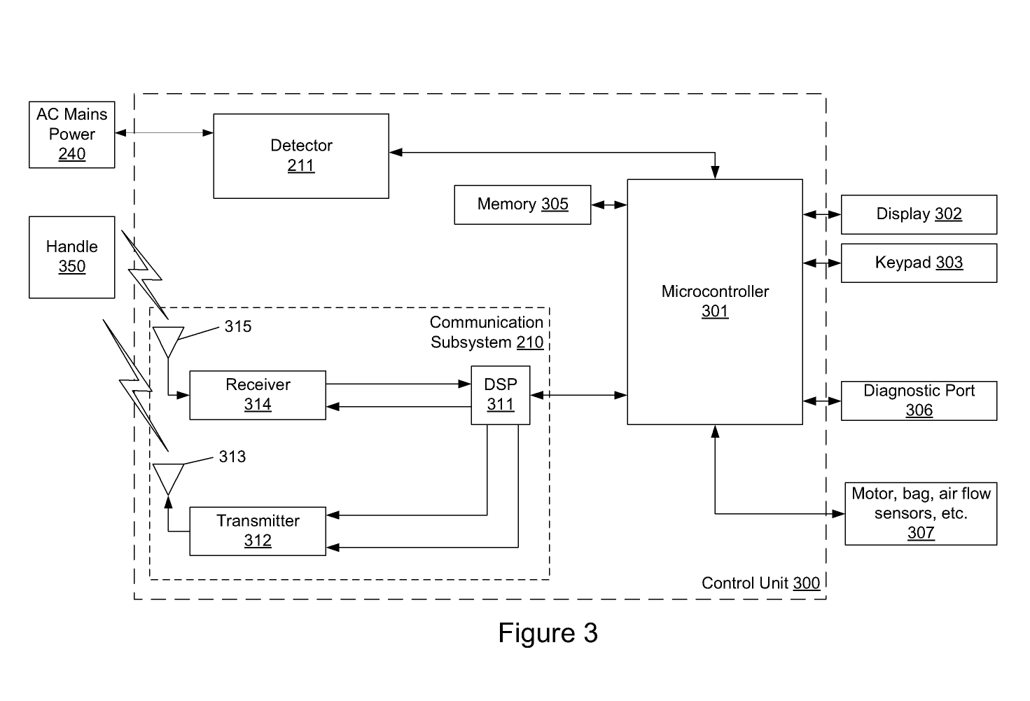

Referring now to FIG. 3, a block diagram of an example control unit 300 with integrated communication subsystem 210 is shown as part of an example central vacuum cleaning control system. Additionally, whereas FIG. 2 illustrated distinct blocks, it is recognized that the embodiment of FIG. 3 illustrates that such blocks or functions can be integrated, for example into microcontroller 301.

In FIG. 3, control unit 300 includes a microcontroller 301 interfacing externally with display 302, keypad 303, diagnostic port 306, and other devices 307 in an example central vacuum cleaning system (comprising devices such as the motor, dust bag, air flow sensors, and others).

Microcontroller 301 also interfaces with RAM 304, flash memory 305, detector 211, and communication subsystem 210. Communication subsystem 210 includes digital signal processing unit 311 interfacing with a receiver 314 and a transmitter 312, along with their respective antennas 315 and 313. Communication subsystem 210 wirelessly communicates with handle 350 of the example vacuum cleaner system to receive control commands for operation of the central vacuum cleaning system.

Memory 305 includes instructions to control the microcontroller 301. The microcontroller 301 controls the display 302 and other devices 307 in the example vacuum cleaner system (such as the motor, dust bag, air flow sensors, and others), receives input from keypad 303, and communicates with handle 350 via communication subsystem 210. Memory 305 also includes instructions to control communication subsystem 210, including its transmitting and receiving frequencies. Memory 305 also includes instructions to determine AC mains power frequency as discussed herein.

When control unit 300 is plugged into AC mains power 240, AC power is supplied to detector 211. If plugged into AC mains power in Europe, the AC mains power supplied will resemble the voltage graph 103 of FIG. 1B (50 Hz mains voltage). If plugged into AC mains power in the US or Canada, the AC mains power supplied will resemble the voltage graph 101 of FIG. 1A (60 Hz mains voltage).

As discussed previously for control unit 200, detector 211 can be configured to notify microcontroller 301 whenever a positive zero crossing occurs in AC main power 240. Over a given time interval, such as 1 second, microcontroller 301 increments a counter whenever detector 211 notifies it that a positive zero crossing has occurred. After the 1 second interval is over, the value of the counter is an indication of the AC power frequency being supplied by AC mains power 240.

Using this indication of AC power frequency, microcontroller 301 maps the indication of AC power frequency to a corresponding wireless communication frequency. Microcontroller 301 then controls communication subsystem 210 so that all subsequent wireless communications will use this corresponding wireless communication frequency.

It can be appreciated that DSP 311, receiver 314 and transmitter 312 can be incorporated into a single integrated circuit package, for example if microcontroller 301 is configured to perform such functionality. It is also possible that instead of separate antennas 313 and 315, a single composite antenna, not shown, is used which can both send and receive wireless communications. Similarly, all or portions of the detector 211 can be integrated into microcontroller 301.

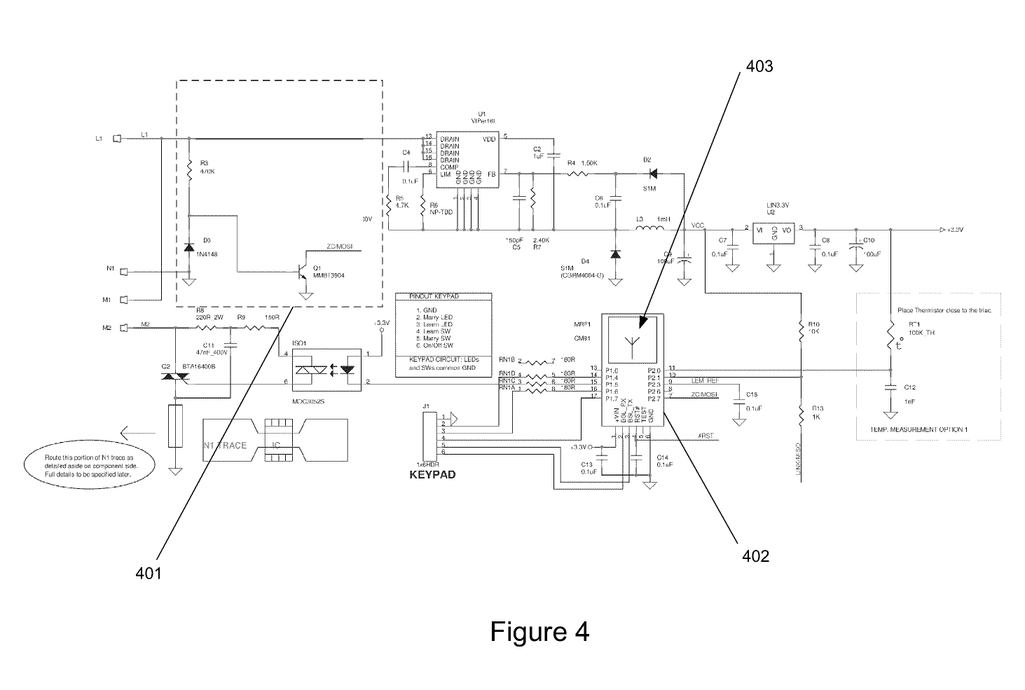

Referring now to FIG. 4, a detailed circuit diagram of an example embodiment of a control unit 400 is shown. Detector 211 can be implemented as zero crossing detector circuit 401, comprising a resister R3, diode D3 and a transistor Q1 connected to processor 402 as shown in FIG. 4. The circuit 401 is configured to be turned on and off by zero crossings in AC mains power 240 to sink current from the processor 402.

Similarly, the control unit 200 of FIG. 2 can be implemented using a microcontroller 402 with integrated communications subsystem 403 and memory, such as a CM91 MRF1 microcontroller from Alutron Modules Inc. of Aurora, Ontario, Canada.

It can be appreciated that the functions of integrated communications subsystem 403 may be provided in a separate microcontroller and transceiver, or receiver and transmitter. A suitable transceiver may be for example a Bluetooth wireless transceiver, many of which are available from a variety of suppliers, such as an OEM Bluetooth-Serial Module, Parani-ESD provided by SENA (www.sena.com).

It can be appreciated that there are alternative methods of measuring AC power frequency than those outlined above. For example, microcontroller 301 or processor 212 may use an interval other than 1 second to determine the AC power frequency. For faster results, microcontroller 301 or processor 212 may use a shorter interval, such as 100 milliseconds. A 100 millisecond interval would provide an indication of AC mains power frequency as multiplying a count of positive zero crossings that occurred within the 100 milliseconds by ten provides the AC mains power frequency.

Alternatively, instead of a fixed time interval a fixed count interval may be used instead. For example, microcontroller 301 or processor 212 may start a timer when it is notified of a first zero crossing, and stop the timer when it has been notified of nine more zero crossings. By dividing the number of zero crossings (in this case the fixed number ten) with the amount of time elapsed between the first zero crossing and the tenth zero crossing, an indication of the AC mains power frequency can be calculated.

It can also be appreciated that mappings for any determined indications of AC mains power frequency to a wireless communication frequency can vary depending on the method used to detect AC mains power frequency. For example, if the AC mains power frequency in Hertz is calculated, then a mapping can be equivalent to “If AC power frequency is 60 Hz then the wireless frequency is 915 MHz”. However, a mapping can be equivalent to “If six positive zero crossings occur within 100 milliseconds, then the wireless frequency is 915 MHz” where a 100 millisecond interval is used instead of a 1 second interval. Such mappings can be used directly from the detected indication of AC main power frequency and no extra calculations are required to map to an appropriate wireless communication frequency. In this case, the mapping is from an indication of AC mains power frequency representing the AC mains power frequency for the purposes described herein. Alternatively, a mapping can be equivalent to “If it takes 166 milliseconds for ten positive zero crossings to occur, then the wireless frequency is 915 MHz”. In this case, microcontroller 301 or processor 212 will also not be required to do any extra calculations to map to an appropriate wireless communication frequency, and the mapping is from the detected indication of AC mains power frequency which represents an AC power frequency in Hertz.

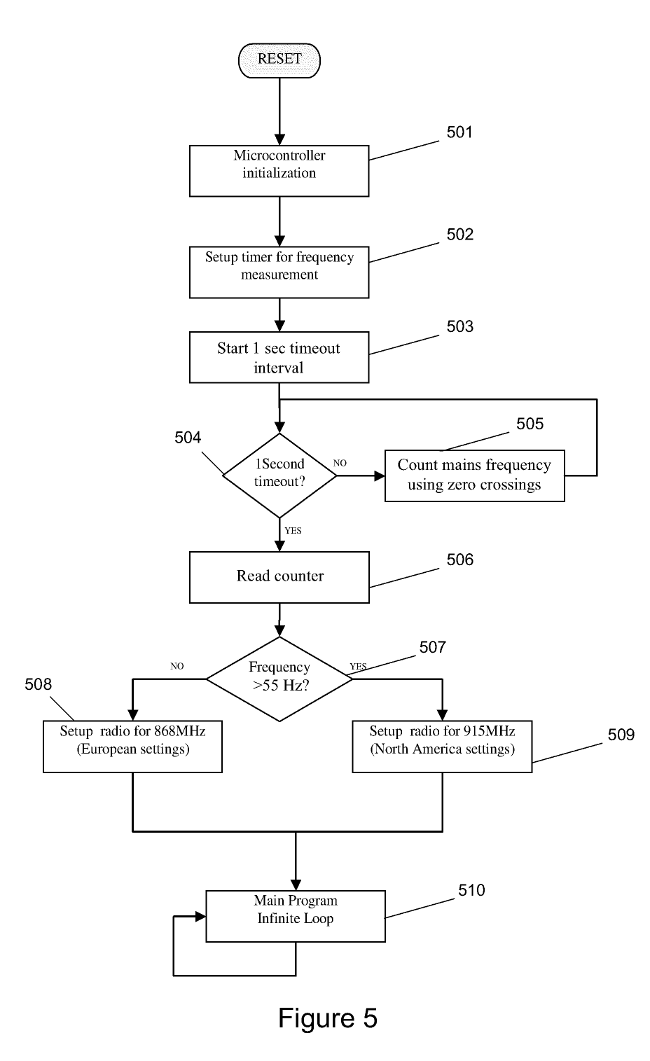

Referring now to FIG. 5, a flowchart disclosing an example method to determine an appropriate wireless communication frequency from AC mains power is shown. The method can be embodied for example in a program stored in memory 202 including instructions for controlling the operation of the microcontroller 301. First, the microcontroller 301 is initialized, as in step 501. A timer is initialized and setup for frequency detection, as in step 502. The timer is set to a 1 second interval and started, as in step 503. During this 1 second timeout (step 504), a counter is used to count the number of zero crossings occurring in the AC power input, as in step 505. After the 1 second timeout expires, the AC mains power frequency is determined by reading the counter, as in step 506. If the determined AC power frequency is more than 55 Hertz, it is mapped to a corresponding wireless transmission frequency of 915 MHz (within the North American unlicensed wireless communication frequency range of 900-928 MHz), as in steps 507 and 509 respectively. However, if the determined AC power frequency is less than 55 Hertz, then it is mapped to a corresponding wireless transmission frequency of 868 MHz (within the European unlicensed wireless communication frequency range of 868.0-868.6 MHz), as in steps 508 and 509 respectively. Once the wireless transmission frequency is mapped, the radio (communication subsystem) is setup to use that frequency for subsequent wireless communications (steps 507 or 508) and a main program loop begins processing for other functions of the applicable appliance, such as, for example, control of a suction motor in a central vacuum cleaning system (step 510). The set wireless communication frequency can be stored in memory 202 for future use.

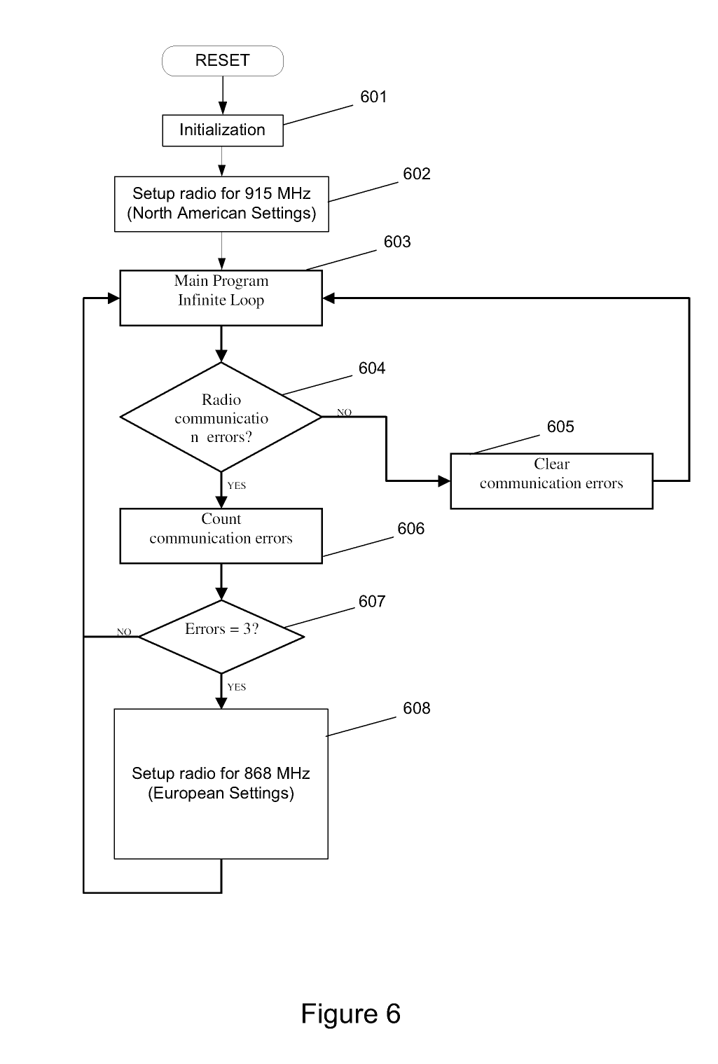

Referring now to FIG. 6, a flowchart is shown disclosing another example method to determine an appropriate wireless transmission frequency for a remote unit similar in communications structure to the control unit 300, for example. For instance, the remote unit may be handle 350, when in use with control unit 300. The method can be embodied for example in a program stored in memory including instructions for controlling the operation of the remote unit. First, a microcontroller in the remote unit is initialized, as in step 601. This initialization may be similar to step 501. The radio in the remote unit is setup to use a wireless transmission frequency of 915 MHz (within the North American unlicensed wireless communication frequency range of 900-928 MHz), as in step 602. A main program loop in the remote unit begins processing for other functions of the applicable appliance, as in step 603. During main program execution, if radio communication is error-free such that errors are not detected (steps 604, and 605), then the main program loop continues. However, if radio communication errors are detected (steps 604), then a counter in the remote unit is used to count the number of radio communication errors (step 606). If the consecutive number of radio communication errors are less than a predetermined number (step 607), the main program loop continues. However, if the consecutive number of radio communication errors exceed a predetermined number (step 607), the radio in the remote unit is setup to change its wireless transmission frequency to 868 MHz (within the European unlicensed wireless communication frequency range of 868.0-868.6 MHz), as in step 608, and the main program loop continues. The method is particularly useful where the remote unit is battery operated with no access to AC mains power. The remote unit may be battery operated.

If the remote unit also has access to the AC mains power then the method of FIG. 5 can also be employed in the remote unit. The ERV central vacuum cleaning system example discussed earlier would be an example of a remote unit having access to AC mains power. An example of a remote unit/control unit combination where each unit has access to AC mains power is a dryer and vent system with wireless booster fan disclosed in U.S. patent application Ser. No. 12/457,980 of J. Vern Cunningham, filed on Jun. 26, 2009, the content of which is hereby incorporated by reference.

In a first aspect an implementation can provide an appliance including a mains power input for accepting AC mains power; a wireless communication subsystem; a power characteristic determinator linked to the mains power input for determining an AC power characteristic of the AC mains power; and a control unit linked to the power characteristic determinator and the wireless communication subsystem, wherein the control unit is configured to set a wireless communication frequency of the wireless communication subsystem within a pre-determined wireless communication frequency range based on the determined AC power characteristic.

The power characteristic determinator can include a processor; a detector for detecting zero crossings in the AC mains power, the detector configured to notify the processor of each detected zero crossing; wherein the processor determines the AC power characteristic from the detected zero crossings over a predetermined time.

The control unit can be configured to set the wireless communication frequency by receiving the determined AC power characteristic from the power characteristic determinator; mapping the determined AC power characteristic to a corresponding wireless communication frequency range using a predetermined table in memory, and controlling the communication subsystem to communicate on the wireless frequency range.

The AC power characteristic determinator can include a frequency determinator linked to the mains power input for determining a AC mains power frequency, wherein the control unit is configured to set for the wireless communication subsystem a wireless communication frequency within a pre-determined wireless communication frequency range based on the determined AC mains power frequency.

The AC power characteristic determinator can include a voltage determinator linked to the mains power input for determining an AC mains power voltage, wherein the control unit is configured to set for the wireless communication subsystem a wireless communication frequency within a pre-determined wireless communication frequency range based on the determined AC mains power voltage.

The AC power characteristic can be determined by determining an indication of the AC mains power frequency and mapping the AC mains power frequency to a wireless communication frequency comprising the determined indication of AC mains power frequency to the wireless communication frequency.

The zero crossing detector can be configured to detect zero crossings from one of the group consisting of positive zero crossing and negative zero crossing.

In a second aspect an implementation can provide a system including an appliance of the first aspect as a first appliance, and a second appliance including a second wireless communication subsystem configured to communicate on a first wireless communication frequency within a first pre-determined wireless communications frequency range; and a second control unit configured to control the second wireless communication subsystem to communicate on an alternate wireless communication frequency within a pre-determined wireless communication frequency range different from the first pre-determined wireless communication frequency range if the second wireless communication subsystem fails to communicate with the first appliance on the first wireless communication frequency.

In a third aspect an implementation can provide a method of setting a wireless communication frequency of an appliance, the method including automatically determining an AC power characteristic from AC mains power of the appliance; automatically mapping the determined AC power characteristic to a wireless communication frequency within a pre-determined wireless frequency range based on the determined AC power characteristic; and automatically setting the wireless communication frequency of the appliance to the mapped wireless communication frequency.

Automatically determining an AC power characteristic can include automatically determining an AC mains power voltage; and wherein the automatically mapping the determined AC power characteristic to a wireless communication frequency can include automatically mapping the determined AC mains power voltage to a wireless communication frequency within a pre-determined wireless frequency range based on the determined AC mains power voltage.

Automatically determining an AC power characteristic can include automatically determining an AC mains power frequency by a counter counting zero crossings in the AC mains power over a predetermined time; and automatically mapping the determined AC power characteristic to a wireless communication frequency can include automatically mapping the determined AC mains power frequency to a wireless communication frequency within a pre-determined wireless frequency range based on the determined AC mains power frequency.

Automatically determining an AC power characteristic can include automatically determining an AC mains power frequency by a timer measuring an amount of time required for a predetermined amount of zero crossings to occur in the AC mains power; and automatically mapping the determined AC power characteristic to the wireless communication frequency can include automatically mapping the determined AC mains power frequency to a wireless communication frequency within a pre-determined wireless frequency range based on the determined AC mains power frequency.

The determination of zero crossings can be from one of the group consisting of positive zero crossings and negative zero crossings.

In a fourth aspect an implementation can provide a method of setting a wireless communication frequency of a system including a first appliance and a second appliance, the method including automatically setting a wireless communication frequency of the first appliance in accordance with the method of the third aspect; the second appliance attempting to communicate with the first appliance on a wireless communication frequency within a first pre-determined wireless communication frequency range, and if the second appliance fails to communicate with the first appliance on the wireless communication frequency within the first pre-determined wireless communication frequency range, then automatically setting the second appliance to communicate on an alternate wireless communication frequency within a second pre-determined wireless communication frequency range different from the first pre-determined wireless communication frequency range.

Adaptations and modifications of the described implementations can be made. Therefore, the above discussed implementations are considered to be illustrative and not restrictive.

While variants have been described in detail in the foregoing specification, it will be understood by those skilled in the art that variations may be made without departing from the scope of the application, being limited only by the appended claims.

1. An appliance comprising:
a mains power input for accepting AC mains power;
a wireless communication subsystem;
a power characteristic determinator linked to the mains power input for determining an AC power characteristic comprising an indication of the AC mains power frequency of the AC mains power; and
a control unit linked to the power characteristic determinator and the wireless communication subsystem, wherein the control unit is configured to set a wireless communication frequency of the wireless communication subsystem within a pre-determined wireless communication frequency range based on the determined AC power characteristic.

2. The appliance of claim 1, wherein the power characteristic determinator comprises:
a processor;
a detector for detecting zero crossings in the AC mains power, the detector configured to notify the processor of each detected zero crossing;
wherein the processor determines the AC power characteristic from the detected zero crossings over a predetermined time.

3. The appliance of claim 1, wherein the control unit is configured to set the wireless communication frequency by receiving the determined AC power characteristic from the power characteristic determinator;
mapping the determined AC power characteristic to a corresponding wireless communication frequency range using a predetermined table in memory, and
controlling the communication subsystem to communicate on the wireless frequency range.

4. The appliance of claim 1, wherein the AC power characteristic determinator comprises:
a frequency determinator linked to the mains power input for determining a AC mains power frequency,
wherein the control unit is configured to set for the wireless communication subsystem a wireless communication frequency within a pre-determined wireless communication frequency range based on the determined AC mains power frequency.

5. The appliance of claim 1, wherein the AC power characteristic determinator comprises:
a voltage determinator linked to the mains power input for determining an AC mains power voltage,
wherein the control unit is further configured to set for the wireless communication subsystem the wireless communication frequency within the pre-determined wireless communication frequency range based on the determined AC mains power voltage.

6. The appliance of claim 1, wherein the AC power characteristic is determined by mapping the AC mains power frequency to a wireless communication frequency.

7. The appliance of claim 2, wherein the zero crossing detector detects zero crossings from one of the group consisting of positive zero crossing and negative zero crossing.

8. A system comprising the appliance of claim 1 as a first appliance, and a second appliance comprising:
a second wireless communication subsystem configured to communicate on a first wireless communication frequency within a first pre-determined wireless communications frequency range; and
a second control unit configured to control the second wireless communication subsystem to communicate on an alternate wireless communication frequency within a pre-determined wireless communication frequency range different from the first pre-determined wireless communication frequency range if the second wireless communication subsystem fails to communicate with the first appliance on the first wireless communication frequency.

9. A method of setting a wireless communication frequency of an appliance, the method comprising:
automatically determining an AC power characteristic comprising an indication of the AC mains power frequency from AC mains power of the appliance;
automatically mapping the determined AC power characteristic to a wireless communication frequency within a pre-determined wireless frequency range based on the determined AC power characteristic; and
automatically setting the wireless communication frequency of the appliance to the mapped wireless communication frequency.

10. The method of claim 9:
wherein the automatically determining an AC power characteristic further comprises automatically determining an AC mains power voltage; and
wherein the automatically mapping the determined AC power characteristic to a wireless communication frequency further comprises automatically mapping the determined AC mains power voltage to the wireless communication frequency within the pre-determined wireless frequency range based on the determined AC mains power voltage.

11. The method of claim 9:
wherein the automatically determining an AC power characteristic comprises automatically determining an AC mains power frequency by a counter counting zero crossings in the AC mains power over a predetermined time; and
wherein the automatically mapping the determined AC power characteristic to a wireless communication frequency comprises automatically mapping the determined AC mains power frequency to a wireless communication frequency within a pre-determined wireless frequency range based on the determined AC mains power frequency.

12. The method of claim 9:
wherein the automatically determining an AC power characteristic comprises automatically determining an AC mains power frequency by a timer measuring an amount of time required for a predetermined amount of zero crossings to occur in the AC mains power; and
wherein the automatically mapping the determined AC power characteristic to the wireless communication frequency comprises automatically mapping the determined AC mains power frequency to a wireless communication frequency within a pre-determined wireless frequency range based on the determined AC mains power frequency.

13. The method of of claim 11, wherein the determination of zero crossings is from one of the group consisting of positive zero crossings and negative zero crossings.

14. A method of setting a wireless communication frequency of a system comprising a first appliance and a second appliance, the method comprising:
automatically setting a wireless communication frequency of the first appliance in accordance with the method of claim 9;
the second appliance attempting to communicate with the first appliance on a wireless communication frequency within a first pre-determined wireless communication frequency range, and if the second appliance fails to communicate with the first appliance on the wireless communication frequency within the first pre-determined wireless communication frequency range, then automatically setting the second appliance to communicate on an alternate wireless communication frequency within a second pre-determined wireless communication frequency range different from the first pre-determined wireless communication frequency range.
